(19) United States
(12) Patent Application Publication
(10) Pub. No.: US 2002/0101657 A1
(43) Pub. Date: Aug. 1, 2002

(54) Stereoscopic display device

(76) Inventors: Jee-hong Min, Gyeonggi-do (KR); Hwan-young Choi, Gyeonggi-do (KR); Moon-gyu Lee, Gyeonggi-do (KR); Sung-min Cho, Seoul (KR); Young-il Kim, Gyeonggi-do (KR)

Correspondence Address: STAAS & HALSEY LLP, 700 11TH STREET, NW, SUITE 500, WASHINGTON, DC, 20001, US

(21) Appl. No.: 09/995,778

(22) Filed: Nov. 29, 2001

(30) Foreign Application Priority Data
Feb. 1, 2001 (KR) 2001-4925

(51) Int. Cl. G02B 5/32; G02B 27/22

(52) U.S. Cl. 359/462; 359/15

(57) ABSTRACT

A stereoscopic display device for compositing and reproducing a plurality of images on a three-dimensional space. The stereoscopic display device includes one or more image sources, a beam splitter, and a holographic optical element, wherein the beam splitter and the holographic optical element are configured to project an image from each image source onto a different space.

### CROSS REFERENCE TO RELATED APPLICATIONS

This application claims the benefit of Korean Application No. 2000-4925 filed Feb. 1, 2001, in the Korean Patent Office, the disclosure of which is incorporated herein by reference.

### BACKGROUND OF THE INVENTION

1. Field of the Invention

The present invention relates to a stereoscopic image display device, and more particularly, to a stereoscopic image display device for compositing and displaying multiple images on a three-dimensional space.

2. Description of the Related Art

An expansive growth in the information and communication field due to rapid development of digital technologies has led to further improvement of information transmitted to individuals in qualitative and quantitative terms. Thus, more attention is directed on how to transfer information rather than on which information to transfer. In image information services, which are one of the most effective ways to transfer information, image information is typically displayed in a two-dimensional picture. However, to transfer information more realistically and effectively, studies on a stereoscopic display device for displaying image information in a three-dimensional image have been actively in progress.

In particular, image display devices for viewing stereoscopic images without the use of special viewing aids such as special glasses or helmets have been developed. These are known as autostereoscopic displays. An autostereoscopic approach chiefly employs lenticular techniques using gabinocular parallax, holography techniques using an interference pattern between an object wave and a reference wave, and image compositing techniques for compositing a furthest background image and a closest foreground image.

The image compositing techniques are disclosed in U.S. Pat. No. 5,886,818 to Summer et. al., entitled “Multi-image Compositing”. FIG. 1 shows a stereoscopic display using multi-image compositing disclosed in Summer et al. Referring to FIG. 1, a stereoscopic display includes a rear projection image source unit 110 having a large screen, an image source unit 112 having a small screen, two aspherical parabolic real image projectors 114, and a reflective beam splitter 116. The real image projector 114 creates a real image projected from the image source unit 112 in a space 104, whereas the beam splitter 116 creates a virtual image projected from the other image source unit 110 in another space 106. Thus, from a point of view of an observer, a real image resides in the foreground, and a virtual image in the background, thereby producing a stereoscopic effect.

However, the stereoscopic display using multi-image compositing as described above has a problem in that the use of two large aspherical parabolic real image projectors makes it impossible to apply such a stereoscopic display to small-sized products such as for example cellular phones. Furthermore, it is significantly difficult to manufacture two aspherical lens having mirror curvatures, and aberrations resulting from geometric defects, which may inevitably occur during the fabrication process, degrade the optical performance of the display.

### SUMMARY OF THE INVENTION

To solve the above problems, it is an object of the present invention to provide a small-sized stereoscopic display device for displaying a stereoscopic image using image compositing techniques.

Additional objects and advantages of the invention will be set forth in part in the description which follows, and, in part, will be obvious from the description, or may be learned by practice of the invention.

Accordingly, to achieve the above and other objects, the present invention provides a stereoscopic display device. The stereoscopic display device includes one or more image sources, a beam splitter, and a holographic optical element, wherein the beam splitter and the holographic optical element are configured to project an image from each image source onto a different space.

In a first embodiment of the stereoscopic display device, a first image source displays a first image and a second image source displays a second image. A first beam splitter transmits a portion of the first image and reflects another portion of the first image. A holographic optical element having an aspherical lens function which reflects the transmitted portion of the first image back onto the first beam splitter which further reflects the transmitted portion of the first image. A second beam splitter reflects the further reflected transmitted portion of the first image and projects the further reflected transmitted portion of the first image onto a first space while projecting the second image from the second image source onto a second space.

In a second embodiment of the stereoscopic display device, a first image source displays a first image and a second image source displays a second image. A reflective holographic optical element having an aspherical lens function reflects the first image and a beam splitter projects the reflected first image onto a first space while projecting the second image onto a second space.

In a third embodiment of the stereoscopic display device, a first image source displays a first image and a second image source displays a second image. A transmissive holographic optical element having an aspherical lens function transmits the first image. A first beam splitter reflects the transmitted first image transmitted and a second beam splitter projects the transmitted and reflected first image onto a first space and projects the second image onto a second space.

In a fourth embodiment of the stereoscopic display device, a first image source displays a first image, a second image source displays a second image and a third image source displays a third image. A first beam splitter transmits a portion of the first image and reflects another portion of the first image. A first reflective holographic optical element having an aspherical lens function reflects the transmitted portion of the first image back onto the first beam splitter which further reflects the transmitted portion of the first image. A second beam splitter transmits a portion of the second image and reflects another portion of the second image while transmitting the further reflected transmitted portion of the first image. A second reflective holographic optical element having an aspherical lens function reflects the transmitted portion of the second image back onto the second beam splitter which further reflects the transmitted portion of the second image. A third beam splitter projects the further reflected transmitted portion of the second image onto a first space, projects the further reflected transmitted portion of the first image onto a second space, and projects the third image onto a third space.

In a fifth embodiment of the stereoscopic display device, a first image source displays a first image, a second image source displays a second image and a third image source displays a third image. A first reflective holographic optical element having an aspherical lens function reflects the first image. A first beam splitter transmits a portion of the second image and reflects another portion of the second image while transmitting the reflected first image. A second reflective holographic optical element having an aspherical lens function reflects the transmitted portion of the second image back onto the first beam splitter which further reflects the transmitted portion of the second image. A second beam splitter projects the further reflected portion of the second image onto a first space, projects the first image onto a second space, and projects the third image onto a third space.

### BRIEF DESCRIPTION OF THE DRAWINGS

The above object and advantages of the present invention will become more apparent by describing in detail preferred embodiments thereof with reference to the attached drawings in which:

FIG. 1 shows a conventional stereoscopic display device using image compositing techniques;

FIG. 2A shows a plan view of a stereoscopic display device according to the present invention;

FIG. 2B shows a functional diagram of a stereoscopic display device according to a first embodiment of the present invention;

FIG. 3 shows a functional diagram of a stereoscopic display device according to a second embodiment of the present invention;

FIG. 4 shows a functional diagram of a stereoscopic display device according to a third embodiment of the present invention;

FIG. 5 shows a functional diagram of a stereoscopic display device according to a fourth embodiment of the present invention; and

FIG. 6 shows a functional diagram of a stereoscopic display device according to a fifth embodiment of the present invention.

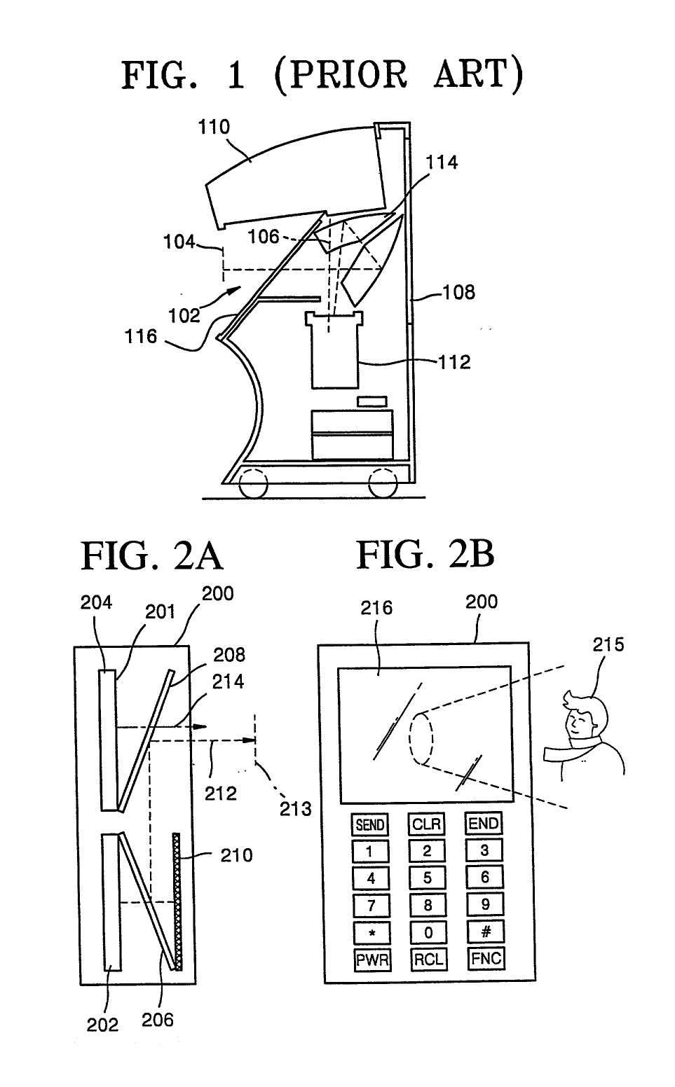

### DESCRIPTION OF THE PREFERRED EMBODIMENTS

Reference will now be made in detail to the present embodiments of the present invention, examples of which are illustrated in the accompanying drawings, wherein like reference numerals refer to like elements throughout.

The terminology holographic optical element is referred to as a hologram used as an optical element and designed to obtain a desired waveform by reproducing or transforming waveforms recorded on hologram regions.

A feature of the present invention is that a stereoscopic display device is implemented with a holographic optical element. A stereoscopic display device according to this invention includes one or more image sources, a beam splitter, and a holographic optical element, and is configured such that the beam splitter and the holographic optical element project images from one or more image sources onto different spaces.

More specifically, this invention employs a reflection or transmission holographic optical element (HOE), which is a diffractive optical element. For example, as is well-known in the art, the reflective or transmissive HOE is made of a hologram that is a diffractive grating consisting of a series of evenly spaced parallel lines by illuminating a plane reference wave and a plane object wave on a recording material such as dichromated gelatine, silver halide emulsion, and photoresist overlying a glass or plastic substrate. In particular, the reflective HOE may be manufactured by illuminating the plane reference wave perpendicularly to the recording surface while illuminating the plane object wave on a back side of the recording surface at a predetermined angle with respect to the reference wave. Furthermore, the transmissive HOE may be fabricated by illuminating a front side of the recording surface with the plane object wave while illuminating a back side thereof with the plane reference wave.

The HOE has several advantages over conventional optical elements. First, multiple functions can be performed with a single HOE. For example, one HOE may serve as a lens, a splitter and an interference filter. Second, HOEs are manufactured with less difficulty than conventional optical elements since the conventional optical elements must undergo surface processing. The HOE is manufactured by recording an image on a photosensitive material in a way similar to taking a photograph, thus the HOE is relatively easy to manufacture uniformly, allowing high volume production. Third, the HOE formed of a thin film is light in weight. Fourth, since the HOE is a record of an interference pattern formed by two coherent beams, it is easier to manufacture HOEs having aspherical lens properties. Fifth, the HOE is cheap and eliminates aberrations occurring during the fabrication.

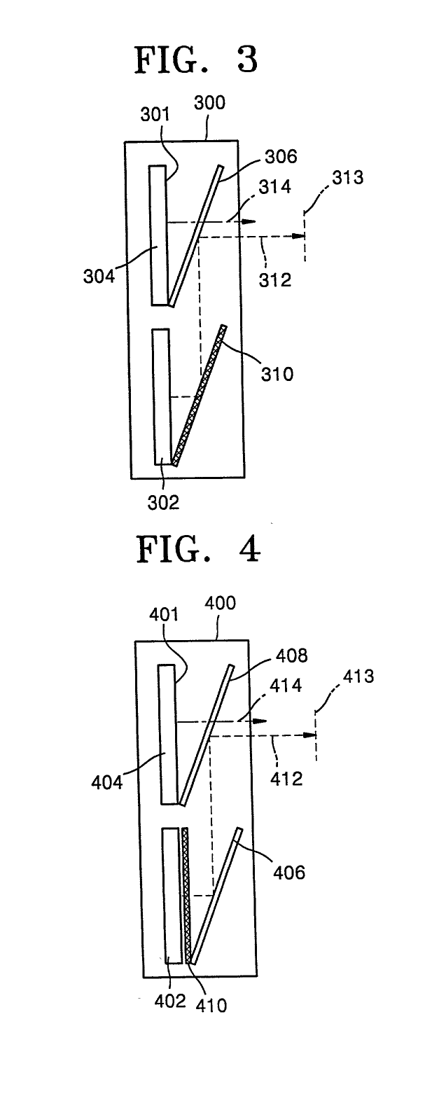

FIGS. 2A and 2B illustrate a stereoscopic display device 200 for image compositing according to the present invention. Referring to FIGS. 2A and 2B, the stereoscopic display device 200 comprises a first image source 202, a second image source 204, a first beam splitter 206, a second beam splitter 208, and a HOE 210. A liquid crystal display (LCD) is used for the first and second image sources 202 and 204, thereby miniaturizing the stereoscopic display device 200. The HOE 210, which is light reflective, has the properties of an aspherical lens to offer a high resolution image while eliminating spherical aberrations.

The first and second image sources 202 and 204 are arranged inline as shown in FIG. 2. The first beam splitter 206 performs a half mirror function to transmit some of a first image projected from the first image source 202 and reflect some of the first image. The first beam splitter 206 forms an interior angle of about 45 degrees or less relative to the first image source 202. The first beam splitter 206 forms an interior angle of about 45 degrees or less relative to the HOE 210. Thus, the first image source 202, the first beam splitter 206, and the HOE 210 are arranged substantially in the form of ‘N’. The second beam splitter 208 forms an interior angle of about 45 degrees or less relative to that of the second image source 204. Thus, the second image source 204 and the second beam splitter 208 are arranged substantially in the form of ‘V’.

With the arrangement as shown in FIGS. 2A and 2B, the stereoscopic display device 200 operates as follows. The first beam splitter 206 reflects some of the first image derived from the first image source 202 and transmits some of the first image. The part of the first image transmitted is reflected back onto the first beam splitter 206 by the reflective HOE 210 having the properties of an aspherical lens. The first image reflected back from the reflective HOE 210 changes into a high resolution image free of spherical aberrations according to the aspherical lens function of the HOE 210.

The first beam splitter 206 reflects the first image from the first image source 202 and the first image reflected back from the HOE 210. The second beam splitter 208 performs the same half mirror function that the first beam splitter 206 performs. The second beam splitter 208 reflects the first image reflected from the first beam splitter 206 and projects the first image onto a space 213 propagating along an optical path denoted by 212. Also, the second beam splitter 208 transmits a second image from the second image source 204 along an optical path denoted by 214.

Thus, a viewer recognizes that the first image from the first image source 202 has been reproduced on the space 213 while the second image from the second image source 204 transmitted by the second beam splitter 208 has been reproduced on a surface 201 of the second image source 204. Thus, two images are reproduced as a foreground and a background in different spaces thereby creating a three-dimensional image.

FIG. 2A shows an application of the stereoscopic display device configured and operated as above to portable terminals such as cellular phones using IMT-2000 or CDMA (Code Division Multiple Access). That is, according to the first embodiment of this invention, a foreground real image 215 derived from the first image source 202 appears closer to the viewer on a screen 216 while the background derived from the second image source 204 appears farther from the viewer than the foreground real image 215, thereby producing a distance between the first and second images. Thus, the viewer observes an image stereoscopically reproduced on a three-dimensional space.

FIG. 3 illustrates a stereoscopic display device 300 according to a second embodiment of the present invention. As shown in FIG. 3, the stereoscopic display device 300 includes a first image source 302, a second image source 304, an HOE 310, and a beam splitter 306. A miniaturized LCD is appropriate for the first and second image sources 302 and 304. The HOE 310 has the properties of an aspherical lens to offer high resolution image free of spherical aberrations. Also, the HOE 310, which is light reflective, performs a half mirror function to transmit some of a first image projected from the first image source 302 and reflect some of the first image.

The first and second image sources 302 and 304 are arranged inline as shown in FIG. 3. The HOE 310 forms about an interior angle of about 45 degrees or less relative to that of the first image source 302. Thus, the first image source 302 and the HOE 310 are arranged substantially in the form of ‘V’. The beam splitter 306 having a half mirror function forms an interior angle of about 45 degrees or less relative to that of the second image source 304, thereby also being arranged substantially in the form of ‘V’.

With configuration shown in FIG. 3, the stereoscopic display device 300 operates as follows. The first image from the first image source 302 is reflected by the HOE 310. The first image reflected by the HOE 310 becomes a high resolution image free of spherical aberrations according to the aspherical lens function of the HOE 310. The beam splitter 306 reflects the first image reflected by the HOE 310 and projects the first image onto a space 313 along an optical path 312. Also, the beam splitter 306 transmits the second image from the second image source 304 along an optical path denoted by 314.

Thus, the viewer recognizes that the first image from the first image source 302 has been reproduced on the space 313 while the second image from the second image source 304 transmitted by the beam splitter 306 has been reproduced on a surface 301 of the second image source 304. Thus, two images are reproduced as a foreground and a background in different spaces thereby creating a three-dimensional image.

FIG. 4 illustrates a stereoscopic display device 400 according to a third embodiment of the present invention. As shown in FIG. 4, the stereoscopic display device 400 includes a first image source 402, a second image source 404, an HOE 410, and first and second beam splitters 406 and 408. A miniaturized LCD is appropriate for the first and second image sources 402 and 404. The HOE 410 has aspherical lens properties to offer high resolution image free of spherical aberrations. Also, the HOE 410 is light transmissive to transmit an image derived from the first image source.

The first and second image sources 402 and 404 are arranged inline as shown in FIG. 4. The HOE 410 is spaced apart a predetermined distance in parallel to the first image source 402. The first beam splitter 406 having a half mirror function forms an interior angle of about 45 degrees or less relative to the HOE 410, being arranged substantially in the form of ‘V’. The second beam splitter 408 having a half mirror function forms an interior angle of about 45 degrees or less relative to that of the second image source 404, also being arranged substantially in the form of ‘V’.

With the configuration shown in FIG. 4, the stereoscopic display device 400 operates as follows. A first image derived from the first image source 402 is transmitted by the HOE 410. The first image transmitted by the HOE 410 becomes a high resolution image free of spherical aberrations by the aspherical lens function of the HOE 410. The first beam splitter 406 reflects the first image transmitted by the HOE 410. Then, the second beam splitter 408 reflects the first image reflected by the first beam splitter 406 in order to project the first image onto a space 413 propagating along an optical path 412. Also, the second beam splitter 408 transmits a second image projected from the second image source 404 along an optical path 414.

Thus, the viewer recognizes that the first image from the first image source 402 has been reproduced on the space 413 while the second image transmitted by the second beam splitter 408 has been reproduced on a surface 401 of the second image source 404. Thus, two images are reproduced as a foreground and a background in different spaces thereby creating a three-dimensional image.

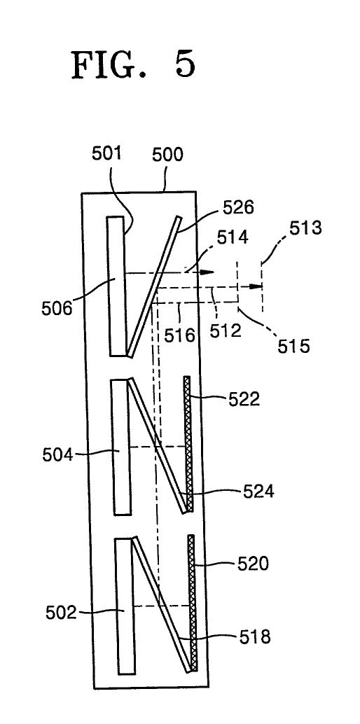

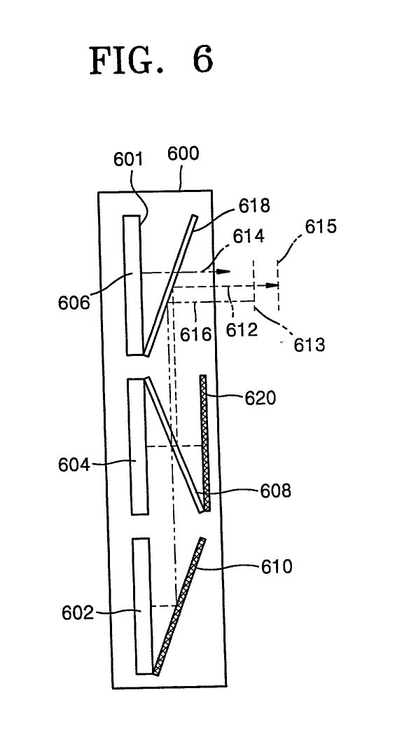

FIG. 5 illustrates a stereoscopic display device 500 according to a fourth embodiment of the present invention. Referring to FIG. 5, the stereoscopic display device 500 includes first, second and third image sources 502, 504, and 506, first through third beam splitters 518, 524, and 526, and first and second HOEs 520 and 522. A miniaturized LCD is suitable for the first through third image sources 502, 504, and 506. The first and second HOEs 520 and 522, which are light reflective, have properties of an aspherical lens to provide a high resolution image while eliminating spherical aberrations.

The first through third image sources 502, 504, and 506 are arranged inline as shown in FIG. 5. The first beam splitter 518 performs a half mirror function to transmit some of a first image projected from the first image source 502 and reflect some of the first image. The first beam splitter 518 forms an interior angle of about 45 degrees or less relative to that of the first image source 502. The first beam splitter 518 forms an interior angle of about 45 degrees or less relative to one end of the first HOE 520. Thus, the first image source 502, the first beam splitter 518, and the first HOE 520 are arranged substantially in the form of ‘N’. The second beam splitter 524 having a half mirror function forms an interior angle of about 45 degrees or less relative to the second image source 504. The second beam splitter 524 forms an interior angle of 45 degrees or less relative to the second HOE 522. Thus, the second image source 504, the first beam splitter 524, and the second HOE 522 are arranged substantially in the form of ‘N’. The third beam splitter 526 having a half mirror function forms an interior angle of about 45 degrees or less relative to the third image source 506. Thus, the third image source 506 and the third beam splitter 526 are arranged substantially in the form of ‘V’.

With the configuration shown in FIG. 5, the stereoscopic display device 500 operates as follows. The first beam splitter 518 reflects some of the first image derived from the first image source 502 and transmits some of the first image. The part of the first image transmitted is reflected back onto the first beam splitter 518 by the first reflective HOE 520 having aspherical lens properties. The part of the first image reflected back from the first reflective HOE 520 changes into a high resolution image free of spherical aberrations according to the aspherical lens function of the first reflective HOE 520.

In the same manner, the second beam splitter 524 reflects some of a second image derived from the second image source 504 and transmits some of the second image. The part of the second image transmitted is reflected back onto the second beam splitter 524 by the second reflective HOE 522. The second image reflected back from the second reflective HOE 524 changes into a high resolution image free of spherical aberrations according to the aspherical lens function of the second reflective HOE 522.

The third beam splitter 526 reflects the first image from the first image source 502, which has been reflected back from the first reflective HOE 520, along an optical path 516 in order to project the first image onto a space 515. The third beam splitter 526 reflects the second image from the second image source 504, which has been reflected back from the second reflective HOE 522, along an optical path 512 in order to project the second image onto a space 513, and transmits a third image from the third image source 506 along an optical path 514.

Thus, the viewer recognizes that the first image from the first image source 502 and the second image from the second image source 504 have been reproduced on the spaces 515 and 513, respectively. Also, the viewer recognizes that the third image from the third image source 506 transmitted by the third beam splitter 518 has been reproduced on a surface 501 of the third image source 506. Thus, three images are reproduced arranged from a foreground to a background in different spaces thereby creating a three-dimensional image.

FIG. 6 illustrates a stereoscopic display device 600 according to a fifth embodiment of the present invention. Referring to FIG. 6, the stereoscopic display device 600 includes first, second and third image sources 602, 604, and 606, first and second beam splitters 608 and 618, and first and second HOEs 610 and 620. A miniaturized LCD is suitable for the first through third image sources 602, 604, and 606. The first reflective HOE 610 has the properties of an aspherical lens to provide a high resolution image free of spherical aberrations and also performs a half mirror function to transmit some of a first image from the first image source 602 and reflects some of the first image.

The first through third image sources 602, 604, and 606 are arranged inline as shown in FIG. 6. The first HOE 610 forms an interior angle of about 45 degrees or less relative to the first image source 602, being arranged approximately in the form of ‘V’. The first beam splitter 608 having a half mirror function forms an interior angle of about 45 degrees or less relative to the second image source 604. The first beam splitter 608 forms an interior angle of about 45 degree or less relative to the second HOE 620. Thus, the second image source 604, the first beam splitter 608, and the second HOE 602 are arranged substantially in the form of ‘N’. The second beam splitter 618 having a half mirror function forms an interior angle of about 45 degrees or less relative to the third image source 606, also being arranged substantially in the form of ‘V’.

The stereoscopic display device 600 configured as shown in FIG. 6 operates as follows. A first image from the first image source 602 is reflected by the first HOE 610 having an aspherical lens function. The first image reflected by the first HOE 610 becomes a high resolution image free of spherical aberrations according to the aspherical lens function of the first HOE 610.

The first beam splitter 608 reflects some of a second image from the second image source 604 while transmitting some of the second image. The part of the second image transmitted is reflected back onto the first beam splitter 608 by the second reflective HOE 620. The second image reflected back from the second reflective HOE 620 changes into a high resolution image free of spherical aberrations according to the aspherical lens function of the second reflective HOE 620.

The second beam splitter 618 reflects the first image from the first image source 602, which has been reflected back from the first reflective HOE 610, onto a space 613 along an optical path 616. Also, the second beam splitter 618 reflects the second image from the second image source 604, which has been reflected back from the second reflective HOE 620, onto a space 615 along an optical path 612, and transmits a third image from the third image source 606 onto a space along an optical path 614.

Thus, the viewer recognizes that the first image from the first image source 602 and the second image from the second image source 604 have been reproduced on the spaces 613 and 615, respectively. Also, the viewer recognizes that the third image from the third image source 606 transmitted by the second beam splitter 618 has been reproduced on a surface 601 of the third image source 606. Thus, three images are reproduced arranged from a foreground to a background in different spaces thereby creating a three-dimensional image.

While this invention has been particularly shown and described with reference to various preferred embodiments of stereoscopic display devices using an HOE, it will be apparent to one of ordinary skill in the art that modifications of the described embodiment may be made without departing from the spirit and scope of the invention. For example, while an LCD has been used as an example of an image source in embodiments of the present invention, other image display such as a cathode-ray tube (CRT) TV may be used in place of the LCD depending on the usage of a stereoscopic display device.

A plurality of image sources employed in one embodiment of the present invention may have the same size, but a first image source for displaying a foreground real image appearing closest on a screen is preferably smaller than the other image sources. A first image source for displaying the foreground image has brightness greater than those of the other image sources such that a first image from the first image source can be displayed sharply on a position closer to an observer than any of the background images. The invention is equally applicable to moving or still images displayed from each image source.

Furthermore, while a beam splitter having a half mirror function for reflecting and transmitting some of an image has been employed in embodiments of the present invention, the beam splitter may be replaced with an HOE, such as for example, one of the reflective HOE and the transmissive HOE described elsewhere in the specification.

Since a stereoscopic display device according to this invention includes a reflective or transmissive HOE having an aspherical lens function, it is easier to manufacture a stereoscopic display device, thus enabling high volume production. Furthermore, this invention allows for miniaturization and thin film formation of a stereoscopic display device, thereby providing for a microminiaturized and lightweight stereoscopic display device.

What is claimed is:

1. A stereoscopic display device comprising:
at least one source of images which displays a plurality of images,
a beam splitter, and
a holographic optical element, wherein the beam splitter and the holographic optical element are configured to project the plurality of images onto corresponding different spaces.

2. The stereoscopic display device of claim 1, wherein the holographic optical element is a light reflective element having an aspherical lens function.

3. The stereoscopic display device of claim 1, wherein the holographic optical element is a light transmissive element having an aspherical lens function.

4. The stereoscopic display device of claim 1, wherein:
the at least one source of images comprises:
a first image source which displays a first image, and
a second image source which displays a second image;
the beam splitter transmits a portion of the first image and reflects another portion of the first image;
the holographic optical element has an aspherical lens function and reflects the transmitted portion of the first image back onto the beam splitter which further reflects the transmitted portion of the first image; and
the stereoscopic display device further comprises a second beam splitter which reflects the further reflected portion of the first image, projects the further reflected portion of the first image onto a first space and projects the second image onto a second space.

5. The stereoscopic display device of claim 1, wherein:
the at least one source of images comprises:
a first image source which displays a first image, and
a second image source which displays a second image;
the holographic element is a reflective holographic optical element which has an aspherical lens function and which reflects the first image; and
the beam splitter projects the reflected first image onto a first space and projects the second image onto a second space.

6. The stereoscopic display device of claim 1, wherein:
the at least one source of images comprises:
a first image source which displays a first image, and
a second image source which displays a second image;
the holographic optical element is a transmissive holographic optical element which has an aspherical lens function and which transmits the first image;
the beam splitter reflects the transmitted first image; and
the stereoscopic display device further comprises a second beam splitter which projects the reflected first image onto a first space and projects the second image onto a second space.

7. The stereoscopic display device of claim 1, wherein:
the at least one source of images comprises:
a first image source which displays a first image,
a second image source which displays a second image, and
a third image source which displays a third image;
the beam splitter transmits a portion of the first image and reflects another portion of the first image;
the holographic optical element is a reflective holographic optical element which has an aspherical lens function and which reflects the transmitted portion of the first image back onto the first beam splitter which further reflects the transmitted portion of the first image; and
the stereoscopic display device further comprises:
a second beam splitter which transmits a portion of the second image, reflects another portion of the second image and transmits the further reflected portion of the first image;
a second reflective holographic optical element which has an aspherical lens function and which reflects the transmitted portion of the second image back onto the second beam splitter which further reflects the transmitted portion of the second image;
a third beam splitter which projects the further reflected portion of the second image onto a first space, projects the further reflected portion of the first image onto a second space, and projects the third image onto a third space.

8. The stereoscopic display device of claim 1, wherein:
the at least one source of images comprises:
a first image source for displaying a first image,
a second image source for displaying a second image, and
a third image source for displaying a third image;
the holographic optical element is a first reflective holographic optical element which has an aspherical lens function and which reflects the first image;
the first beam splitter transmits a portion of the second image, reflects another portion of the second image, and transmits the reflected first image; and
the stereoscopic display device further comprises:
a second reflective holographic optical element which has an aspherical lens function and which reflects the transmitted portion of the second image back onto the beam splitter which further reflects the transmitted portion of the second image; and
a second beam splitter which projects the further reflected portion of the second image onto a first space, projects the reflected first image onto a second space, and projects the third image onto a third space.

9. A stereoscopic display device comprising:
an image source which displays a plurality of images;
a beam splitter; and
a holographic optical element, wherein the beam splitter and the holographic optical element project the plurality of images onto corresponding different spaces.

10. The stereoscopic display device of claim 9, wherein:
the image source displays first and second images;
the beam splitter transmits a portion of the first image;
the holographic optical element has an aspherical lens function and reflects the portion of the first image back onto the beam splitter which further reflects the portion of the first image; and
the stereoscopic display device further comprises a second beam splitter which reflects and projects the further reflected portion of the first image onto a first space and which projects the second image onto a second space.

11. The stereoscopic display device of claim 9, wherein:
the image source displays first and second images;
the holographic optical element is a reflective holographic optical element which has an aspherical lens function and which reflects the first image; and
the beam splitter projects the reflected first image onto a first space and projects the second image onto a second space.

12. The stereoscopic display device of claim 9, wherein:
the image source displays first and second images;
the holographic optical element is a transmissive holographic optical element which has an aspherical lens function and which transmits the first image;
the beam splitter reflects the transmitted first image; and
the stereoscopic display device further comprises a second beam splitter which projects the reflected first image onto a first space and projects the second image onto a second space.

13. The stereoscopic display device of claim 9, wherein:
the image source displays first, second and third images;
the beam splitter transmits a portion of the first image;
the holographic optical element is a reflective holographic optical element which has an aspherical lens function and which reflects the portion of the first image back onto the beam splitter which further reflects the portion of the first image; and
the stereoscopic display device further comprises:
a second beam splitter which transmits a portion of the second image and transmits the further reflected portion of the first image,
a second reflective holographic optical element which has an aspherical lens function and which reflects the portion of the second image back onto the second beam splitter which further reflects the portion of the second image, and
a third beam splitter which projects the further reflected portion of the second image onto a first space, projects the further reflected portion of the first image onto a second space, and projects the third image onto a third space.

14. The stereoscopic display device of claim 9, wherein:
the image source displays first, second and third images;
the holographic optical element is a reflective holographic optical element which has an aspherical lens function and which reflects the first image;
the beam splitter transmits a portion of the second image and transmits the reflected first image; and
the stereoscopic display device further comprises:
a second reflective holographic optical element which has an aspherical lens function and which reflects the portion of the second image back onto the beam splitter which further reflects the portion of the second image, and
a second beam splitter which projects the further reflected portion of the second image onto a first space, projects the reflected first image onto a second space, and projects the third image onto a third space.

15. A stereoscopic display device comprising:
a plurality of image sources;
at least one beam splitter; and
at least one holographic optical element, wherein the at least one beam splitter and the at least one holographic optical element are configured to project an image from each of the plurality of image sources onto a corresponding different space.

16. The stereoscopic display device of claim 15, wherein:
the plurality of image sources are arranged inline;
the at least one holographic optical element is a reflective holographic element having a spherical lens function and is arranged at an angle forming a “V” with respect to one of the plurality of image sources;
the at least one beam splitter is arranged at an angle forming a second “V” with respect to another of the plurality of image sources; and
a first image is communicated from the one of the plurality of image sources to a first space via the reflective holographic element and the at least one beam splitter and a second image is communicated from the another of the plurality of image sources to a second space via the at least one beam splitter.

17. The stereoscopic display device of claim 15, wherein:
the plurality of image sources are arranged inline;
the at least one holographic optical element is a reflective holographic element having a spherical lens function;
one of the plurality of image sources, a first of the at least one beam splitter and the at least one holographic optical element are arranged at relative angles forming an “N”;
another of the plurality of image sources is arranged at an angle forming a “V” with respect to a second of the at least one beam splitter; and
a first image is communicated from the one of the plurality of image sources to a first space via the first of the at least one beam splitter, the at least one holographic element and the second of the at least one beam splitter and a second image is communicated from the another of the plurality of image sources to a second space via the second of the at least one beam splitter.

18. The stereoscopic display device of claim 15, wherein:
the plurality of image sources are arranged inline;
the at least one holographic optical element is a transmissive holographic element having a spherical lens function;
the at least one holographic optical element is arranged parallel to one of the plurality of image sources;
at least one holographic optical element and a first of the at least one beam splitter are arranged at a relative angle forming a “V”;
another of the plurality of image sources is arranged at an angle forming a “V” with respect to a second of the at least one beam splitter; and
a first image is communicated from the one of the plurality of image sources to a first space via the at least one holographic element, the first of the at least one beam splitter, and the second of the at least one beam splitter and a second image is communicated from the another of the plurality of image sources to a second space via the second of the at least one beam splitter.

19. The stereoscopic display device of claim 15, wherein:
the plurality of image sources are arranged inline;
first and second of the at least one holographic optical element are each a reflective holographic element having a spherical lens function;
a first of the plurality of image sources, a first of the at least one beam splitter and the first of the at least one holographic optical element are arranged at relative angles forming a first “N” arrangement;
a second of the plurality of image sources, a second of the at least one beam splitter and the second of the at least one holographic optical element are arranged at relative angles forming a second “N” arrangement;
a third of the plurality of image sources is arranged at an angle forming a “V” arrangement with respect to a third of the at least one beam splitter; and
a first image is communicated from the first of the plurality of image sources to a first space via the first “N” arrangement and the second and third of the at least one beam splitter, a second image is communicated from the second of the plurality of image sources to a second space via the second “N” arrangement and the third of the at least one beam splitter, and a third image is communicated from the third of the plurality of image sources to a third space via the “V” arrangement.

20. The stereoscopic display device of claim 15, wherein:
the plurality of image sources are arranged inline;
first and second of the at least one holographic optical element are each a reflective holographic element having a spherical lens function;
a first of the plurality of image sources and the first of the at least one holographic optical element are arranged at relative angles forming a first “V” arrangement;
a second of the plurality of image sources, a first of the at least one beam splitter and the second of the at least one holographic optical element are arranged at relative angles forming an “N” arrangement;
a third of the plurality of image sources is arranged at an angle forming a second “V” arrangement with respect to a third of the at least one beam splitter; and
a first image is communicated from the first of the plurality of image sources to a first space via the first “V” arrangement, the first of the at least one beam splitter and the second of the at least one beam splitter, a second image is communicated from the second of the plurality of image sources to a second space via the “N” arrangement and the second of the at least one beam splitter, and a third image is communicated from the third of the plurality of image sources to a third space via the “V” arrangement.

21. The stereoscopic display device of claim 1, wherein the beam splitter is a holographic optical element.

22. The stereoscopic display device of claim 9, wherein the beam splitter is a holographic optical element.

23. The stereoscopic display device of claim 15, wherein the at least one beam splitter is a holographic optical element.

24. A stereoscopic display device comprising:
a plurality of image sources;
a beam splitter; and
a holographic optical element, wherein:
the beam splitter and the holographic optical element are arranged to project an image from each of the plurality of image sources onto a corresponding different space.

25. The stereoscopic display device of claim 24, wherein the beam splitter is a holographic optical element.

26. The stereoscopic display device of claim 24, wherein the beam splitter has a half mirror function.

27. The stereoscopic display device of claim 24, wherein:
a first of the plurality image sources displays a foreground image which is smaller in size than an image displayed by any of the other of the plurality of image sources.

28. The stereoscopic display device of claim 24, wherein:
a first of the plurality image sources displays a foreground image which is brighter than an image displayed by any of the other of the plurality of image sources.

29. The stereoscopic display device of claim 24, wherein each image is a still image.

30. The stereoscopic display device of claim 24, wherein at least one of the images is a moving image.

31. The stereoscopic display device of claim 24, wherein at least one of the image sources is a liquid crystal display.
